(19) United States
(12) Patent Application Publication
(10) Pub. No.: US 2007/0148354 A1
(43) Pub. Date: Jun. 28, 2007

(54) Methods for improving coating adhesion

(76) Inventors: Shengkui Hu, Baden, PA (US); Deborah Hayes, Verona, PA (US); Kaliappa G. Ragunathan, Pittsburgh, PA (US); Sun QiaoLi, Teda (CN)

Correspondence Address: PPG INDUSTRIES INC;INTELLECTUAL PROPERTY DEPT, ONE PPG PLACE, PITTSBURGH, PA, 15272, US

(21) Appl. No.: 11/315,614

(22) Filed: Dec. 22, 2005

(51) Int. Cl. B05D 3/00

(52) U.S. Cl. 427/299

(57) ABSTRACT

Methods for improving adhesion between a coating and a substrate using compositions comprising chlorinated polyolefin and a compound comprising ethylene vinyl acetate are disclosed.

### FIELD OF THE INVENTION

The present invention relates to methods for improving the adhesion between a coating and a substrate comprising applying to the substrate a composition comprising a chlorinated polyolefin and a compound comprising ethylene vinyl acetate.

### BACKGROUND INFORMATION

Many substrates have applied to thereto one or more coatings, which typically serve a decorative and/or protective function. There are often problems associated with the adhesion of the coatings to the substrate, particularly certain substrates such as those made from thermoplastic and thermosetting polymeric materials. Such coatings, once applied, may flake, crack or otherwise be removed from the substrate as a result of time, chemical exposure, mechanical stresses and the like. This is particularly true of flexible substrates. Improved adhesion between substrates and coatings is therefore desired.

### SUMMARY OF THE INVENTION

The present invention is directed to methods for improving the adhesion between a coating and a substrate comprising applying to the substrate a composition comprising:

(a) a chlorinated polyolefin; and

(b) a compound comprising ethylene vinyl acetate, wherein the substrate is ethylene vinyl acetate foam (“EVA foam”).

The present invention is further directed to methods for improving the adhesion between a substrate and a coating, comprising applying to the substrate a composition comprising:

(a) a chlorinated polyolefin; and

(b) a compound comprising ethylene vinyl acetate, wherein the substrate is polyurethane; and the composition excludes epoxy.

The present invention is further directed to methods for improving the adhesion between a substrate and a coating, comprising applying to the substrate a composition comprising:

(a) a chlorinated polyolefin; and

(b) a compound comprising ethylene vinyl acetate, wherein the substrate is fiberglass-reinforced plastic.

The present invention is further directed to methods for improving the adhesion between a substrate and a coating, comprising applying to the substrate a composition comprising:

(a) a chlorinated polyolefin; and

(b) a compound comprising ethylene vinyl acetate, wherein the substrate is metallic,

### DETAILED DESCRIPTION OF THE INVENTION

The present invention is directed to methods for improving the adhesion between a coating and a substrate comprising applying to the substrate a composition comprising a chlorinated polyolefin and a compound comprising ethylene vinyl acetate. This composition is sometimes referred to herein as the “adhesion promoting composition”, “adhesion promoter” and variants thereof. The substrate can be EVA foam, polyurethane, fiberglass-reinforced plastic, and/or metal. In certain embodiments, such as when the substrate is polyurethane, the composition excludes epoxy, such as epoxy resins.

Any chlorinated polyolefin can be used in the present invention, provided the chlorine content described below is met. Suitable chlorinated polyolefins include polyethylene, polypropylene, ethylene-propylene copolymer, polyisobutylene, polybutene, and ethylene-vinyl acetate copolymer. The chlorinated polyolefin may have a chlorine content of 10 to 65 percent by weight, such as 18 to 30 by weight, based upon the total weight of the monomer.

Commercially available chlorinated polyolefins include, for example, HARDLEN 15 LLB (chlorine content: 30% by weight), HARDLEN 14 LLB (chlorine content: 27% by weight), HARDLEN 14 ML (chlorine content: 26.5% by weight) and HARDLEN BS-40 (chlorine content: 40% by weight) (products by Toyo Kasei KK); SUPERCHLON 832 L (chlorine content: 27% by weight), SUPERCHLON 773 H (chlorine content: 32% by weight) and SUPERCHLON L-206 (chlorine content: 32% by weight) (products by Nippon Seishi KK); and CP 730-1, AP 550-1, CP-515-2, CP 153-2 (chlorine content: between 18 and 23% by weight) (products by Eastman).

The compositions of the present invention further comprise a compound comprising ethylene vinyl acetate (“EVA”) having an EVA content (in weight %) of 9 to 40, such as 25 to 32 weight percent. “A compound comprising EVA”, and like terms, refer to EVA polymer itself or polymers comprising EVA monomer and one or more other reactive monomers. Such polymers include copolymers of EVA and vinyl alchol. When the EVA is introduced with other monomers in polymer form, the amount of EVA used in the polymer is used to determine the weight percent of EVA in the composition. A “compound comprising EVA”, according to the present invention, specifically excludes a carboxyl modified resin of EVA and/or an EVA copolymer, and a graft polymer of a carboxylic acid, such as an unsaturated dicarboxylic acid and EVA and/or an EVA copolymer.

The composition may also include a solvent. Suitable solvents include water, organic solvent(s) and/or mixtures thereof. Suitable solvents include glycols, glycol ether alcohols, alcohols, ketones, aromatics, such as xylene and toluene, acetates, mineral spirits, naphthas and/or mixtures thereof. “Acetates” include the glycol ether acetates. In certain embodiments, the solvent is a non-aqueous solvent. “Non-aqueous solvent” and like terms means that less than 50 percent of the solvent is water. For example, less than 10 percent, or even less than 5 percent of the solvent can be water. It will be understood that mixtures of solvents, including or excluding water in an amount of less than 50 percent, can constitute a “non-aqueous solvent”. In certain embodiments of the invention, HAPs-free solvents are utilized. As used herein, the terms “HAPs free” means materials not on the HAPs list (42 U.S.C. 7412).

The compositions used in the present invention can be prepared, for example, by adding the chlorinated polyolefin and a compound comprising ethylene vinyl acetate to a solvent, such as with stirring. The chlorinated polyolefin may typically comprise 1 to 5 weight percent of the total composition, such as 3 to 4 weight percent. The EVA may typically comprise 1 to 5 weight percent of the total composition, such as 3 to 4 weight percent. The chlorinated polyolefin and/or compound comprising EVA can be in the form of a solution, such as one ranging between 0.1 and 25 weight percent of chlorinated polyolefin and/or compound comprising EVA. Any suitable solvent can be used in either the chlorinated polyolefin and compound comprising EVA solutions, such as any of those described above.

It will be appreciated that the chlorinated polyolefin and the compound comprising EVA blended together in the composition and are not polymerized. In certain embodiments, the compositions used in the present invention specifically exclude melamine resin. In certain other embodiments, they specifically exclude optical brighteners, chlorinated rubbers, isocyanate such as polyisocyanate, and/or epoxy resins.

The compositions used in the present invention can further comprise a graft copolymer, in which a chlorinated polyolefin and acrylic polyol are grafted together. Suitable chlorinated polyolefins are those described above; the chlorinated polyolefin used in the copolymer can be the same or different as the other chlorinated polyolefin. Any suitable acrylic polyol can be used, such as those disclosed in U.S. Pat. No. 6,316,119 at column 2, lines 51-61, and made as taught in the '119 patent, incorporated by reference herein. The graft copolymer can be prepared according to any means known in the art, such as those described in U.S. Pat. No. 5,955,545. The copolymer can comprise chlorinated polyolefin and acrylic polyol in a molar ratio of 1:20, such as 1:10. When used in the present compositions, the copolymer may typically comprise 1 to 10 weight percent of the total composition, such as 1 to 5 weight percent.

In certain embodiments, the adhesion promoter consists essentially of chlorinated polyolefin and a compound comprising EVA, and optionally a graft chlorinated polyolefin/acrylic polyol.

The adhesion promoting compositions can also comprise one or more additives such as colorants, crosslinkers, extenders, UV absorbers, light stabilizers, plasticizers, surfactants, leveling agents, adhesion promoters, rheology modifiers, hindered amine light stabilizers, and wetting agents. If used, these additives typically comprise up to 0.5 weight percent of the total weight of the composition.

The adhesion promoting composition of the present invention may, also include a colorant. As used herein, the term “colorant” means any substance that imparts color and/or other opacity and/or other visual effect to the composition. The colorant can be added to the coating in any suitable form, such as discrete particles, dispersions, solutions and/or flakes. A single colorant or a mixture of two or more colorants can be used in the coatings of the present invention.

Example colorants include pigments, dyes and tints, such as those used in the paint industry and/or listed in the Dry Color Manufacturers Association (DCMA), as well as special effect compositions. A colorant may include, for example, a finely divided solid powder that is insoluble but wettable under the conditions of use. A colorant can be organic or inorganic and can be agglomerated or non-agglomerated. Colorants can be incorporated into the coatings by use of a grind vehicle, such as an acrylic grind vehicle, the use of which will be familiar to one skilled in the art.

Example pigments and/or pigment compositions include, but are not limited to, carbazole dioxazine crude pigment, azo, monoazo, disazo, naphthol AS, salt type (lakes), benzimidazolone, condensation, metal complex, isoindolinone, isoindoline and polycyclic phthalocyanine, quinacridone, perylene, perinone, diketopyrrolo pyrrole, thioindigo, anthraquinone, indanthrone, anthrapyrimidine, flavanthrone, pyranthrone, anthanthrone, dioxazine, triarylcarbonium, quinophthalone pigments, diketo pyrrolo pyrrole red (“DPPBO red”), titanium dioxide, carbon black and mixtures thereof. The terms “pigment” and “colored filler” can be used interchangeably.

Example dyes include, but are not limited to, those that are solvent and/or aqueous based such as pthalo green or blue, iron oxide, bismuth vanadate, anthraquinone, perylene, aluminum and quinacridone.

Example tints include, but are not limited to, pigments dispersed in water-based or water miscible carriers such as AQUA-CHEM 896 commercially available from Degussa, Inc., CHARISMA COLORANTS and MAXITONER INDUSTRIAL COLORANTS commercially available from Accurate Dispersions division of Eastman. Chemical, Inc.

As noted above the colorant can be in the form of a dispersion including, but not limited to, a nanoparticle dispersion. Nanoparticle dispersions can include one or more highly dispersed nanoparticle colorants and/or colorant particles that produce a desired visible color and/or opacity and/or visual effect. Nanoparticle dispersions can include colorants such as pigments or dyes having a particle size of less than 150 nm, such as less than 70 nm, or less than 30 nm. Nanoparticles can be produced by milling stock organic or inorganic pigments with grinding media having a particle size of less than 0.5 nm. Example nanoparticle dispersions and methods for making them are identified in U.S. Pat. No. 6,875,800 B2, which is incorporated herein by reference. Nanoparticle dispersions can also be produced by crystallization, precipitation, gas phase condensation, and chemical attrition (i.e., partial dissolution). In order to minimize re-agglomeration of nanoparticles within the coating, a dispersion of resin-coated nanoparticles can be used. As used herein, a “dispersion of resin-coated nanoparticles” refers to a continuous phase in which is dispersed discreet “composite microparticles” that comprise a nanoparticle and a resin coating on the nanoparticle. Example dispersions of resin-coated nanoparticles and methods for making them are identified in U.S. application Ser. No. 10/876,315 filed Jun. 24, 2004, which is incorporated herein by reference, and U.S. application Ser. No. 10/876,031 filed Jun. 24, 2004, which is also incorporated herein by reference.

Example special effect compositions that may be used in the coating of the present invention include pigments and/or compositions that produce one or more appearance effects such as reflectance, pearlescence, metallic sheen, phosphorescence, fluorescence, photochromism, photosensitivity, thermochromism, goniochromism and/or color-change. Additional special effect compositions can provide other perceptible properties, such as opacity or texture. In a non-limiting embodiment, special effect compositions can produce a color shift, such that the color of the coating changes when the coating is viewed at different angles. Example color effect compositions are identified in U.S. Pat. No. 6,894,086 B2, incorporated herein by reference. Additional color effect compositions can include transparent coated mica and/or synthetic mica, coated silica, Coated alumina, a transparent liquid crystal pigment, a liquid crystal coating and/or any composition wherein interference results from a refractive index differential within the material and not because of the refractive index differential between the surface of the material and the air.

In certain non-limiting embodiments, a photosensitive composition and/or photochromic composition, which reversibly alters its color when exposed to one or more light sources, can be used in the compositions of the present invention. Photochromic and/or photosensitive compositions can be activated by exposure to radiation of a specified wavelength. When the composition becomes excited, the molecular structure is changed and the altered structure exhibits a new color that is different from the original color of the composition. When the exposure to radiation is removed, the photochromic and/or photosensitive composition can return to a state of rest, in which the original color of the composition returns. In one non-limiting embodiment, the photochromic and/or photosensitive composition can be colorless in a non-excited state and exhibit a color in an excited state. Full color-change can appear within milliseconds to several minutes, such as from 20 seconds to 60 seconds. Example photochromic and/or photosensitive compositions include photochromic dyes.

In a non-limiting embodiment, the photosensitive composition and/or photochromic composition can be associated with and/or at least partially bound to, such as by covalent bonding, a polymer and/or polymeric materials of a polymerizable component. In contrast to some coating compositions in which the photosensitive composition may migrate out of the coating and crystallize into the substrate, the photosensitive composition and/or photochromic composition associated with and/or at least partially bound to a polymer and/or polymerizable component in accordance with a non-limiting embodiment of the present invention, have minimal migration out of the coating. Example photosensitive compositions and/or photochromic compositions and methods for making them are identified in U.S. application Ser. No. 10/892,919 filed Jul. 16, 2004 and incorporated herein by reference.

In general, the colorant can be present in the coating composition in an amount sufficient to impart the desired visual and/or color effect. The colorant, if used, may comprise from 1 to 65 weight percent of the present compositions, such as from 3 to 40 weight percent or 5 to 35 weight percent, with weight percent based on the total weight of the compositions.

As stated above, the present invention is directed to methods for improving adhesion between a substrate and a coating, comprising applying to the substrate any of the adhesion promoting compositions described above. The coating can be any subsequently added coating, used for decorative, protective and/or functional purposes, such as those described below. It will be appreciated that the present invention is directed to improving adhesion between a substrate and a coating, and not between two substrates, such as two shoe components. The methods of the present invention are particularly effective in promoting adhesion over EVA foam, polyurethane, fiberglass-reinforced plastic and/or metal. It will be appreciated that many of these substrates are flexible substrates. As used herein, “flexible substrate” and like terms refer to substrates that can undergo mechanical stresses, such as bending or stretching and the like, without significant irreversible change. In certain embodiments, the flexible substrates are compressible substrates. “Compressible substrate” and like terms refer to substrates capable of undergoing a compressive deformation and returning to substantially the same shape once the compressive deformation has ceased. The term “compressive deformation” means a mechanical stress that reduces the volume at least temporarily of a substrate in at least one direction. “EVA foam” can comprise open cell foam and/or closed cell foam. “Open cell foam” means that the foam comprises a plurality of interconnected air chambers; “closed cell foam” means that the foam comprises discrete closed pores. EVA foam can include flat sheets or slabs or molded EVA foams, such as shoe midsoles. Different types of EVA foam can have different types of surface porosity. Molded EVA can comprise a dense surface or “skin”, whereas flat sheets or slabs can exhibit a porous surface. Polyurethane substrates according to the present invention include aromatic, aliphatic and hybrid (hybrid examples are silicone polyether or polyester urethane and silicone carbonate urethane) polyester or polyether based thermoplastic urethane, such as DESMOPAN, TEXIN, PURSIL, and CARBOSlL. “Fiberglass-reinforced plastic” includes any plastic to which fiberglass has been added and/or applied. By “plastic” is meant any of the common thermoplastic or thermosetting synthetic non-conductive materials, including thermoplastic olefins such as polyethylene and polypropylene, thermoplastic urethane, polycarbonate, sheet molding compound, reaction-injection molding compound, acrylonitrile-based materials, nylon, and the like. “Metals” include all metals such as Mg, Al, Ti, and the like. The substrates coated according to the present invention are not polyolefins or rubber.

All or part of the substrate can be coated using the adhesion promoting compositions, which may be applied by any means known in the art. Examples include, but are not limited to, brushing, wiping, spraying, dipping or flowcoating. The adhesion promoter can be used in any amount to yield improved adhesion between the substrate and any additional coating layers applied.

Depending on the needs of the user, and the particular substrate involved, the substrate may be pretreated prior to application of the adhesion promoting compositions. Such pretreatment may include, for example, plasma treatment, flame treatment, abrasive sanding, UV irradiation and/or chemical cleaning with a solvent.

After application of the adhesion promoting composition, it can be cured, such as by flashing at room temperature and then optionally baked. The baking operation can be carried out, for example, at a temperature in the range of from 50 to 60° C., for 15 to 25 minutes. It is well within the skill of one practicing in the art to determine appropriate cure conditions, particularly taking in to consideration the substrate to which the adhesion promoter is being applied. The dry film thickness of the adhesion promoter can range from 0.01 to 1.0 mils, and is usually from 0.1 to 0.4 mils.

Typically, a primer and/or a basecoat composition different from the adhesions promoting composition may be subsequently applied on top of the adhesion promoter described herein. The primer and/or basecoat may each, be pigmented or unpigmented. A clear coating composition may optionally be applied to the basecoat. The primer and/or basecoat and/or clearcoat may be applied after baking the film of the adhesion promoting composition, or may be applied in a “wet-on-wet” configuration prior to the baking operation; that is, the adhesion promoter can be cured or uncured prior to the application of subsequent coating layers. Any suitable primer, basecoat and/or clearcoat can be used based upon the needs of the user and the particular substrate, and the particular use for the substrate. Adhesion of the subsequent coating layers (i.e. primer, basecoat, and/or clearcoat) will be enhanced as compared to a substrate coated without the adhesion promoter described herein. Thus, it will be understood that the adhesion promoting composition described herein may be applied as a separate layer and not as an additive in another coating.

As used herein, unless otherwise expressly specified, all numbers such as those expressing values, ranges, amounts or percentages may be read as if prefaced by the word “about”, even if the term does not expressly appear. Any numerical range recited herein is intended to include all sub-ranges subsumed therein. Plural encompasses singular and vice versa. For example, while the invention has described in terms of “a” chlorinated polyolefin, “a” compound comprising ethylene vinyl acetate, “an” acrylic polyol, and “a” solvent, one or more of all of these ingredients can be used. Also, as used herein, the term “polymer” is meant to refer to prepolymers, oligomers and both homopolymers and copolymers; the prefix “poly” refers to two or more.

### EXAMPLES

The following examples are intended to illustrate the invention; and should not be construed as limiting the invention in any way.

### Example 1

An adhesion promoter according to the present invention was prepared by blending the following with a tongue blade for about five minutes:

TABLE 1

| | Resin | | Material | Sol'n | Total |
|---|---|---|---|---|---|
| Material Name | Solids | Solvents | Solids | Weight | Weight |
| 5% solution* CPO¹ | 0.500 | 9.500 | 0.0500 | 10.000 | 5.00 |
| 5% solution* ethylene | 0.500 | 9.500 | 0.0500 | 10.000 | 5.00 |
| vinyl acetate² | | | | | |
| Methyl | — | 30.000 | 0.000 | 30.00 | 15.00 |
| cyclohexane/SSE-86 | | | | | |
| n-Butyl acetate (50/50 | | | | | |
| blend)* | | | | | |
| | 1.00 | 49.00 | | 50.00 | 25.00 |
| Solids = | 2.00% | | | | |

*Solvent = 50/50 blend Methylcyclohexane/n-BA ref. 05-041-94.
¹CPO 343-1 from Eastman, Mw 10,000-30,000.
²ELVAX 150W from DuPont.

Ethylene vinylene shoe midsoles were cleaned with a solvent blend (MIBK, ethyl acetate, DOWANOL PMA in a 42:40:18 molar ratio). The solvent was allowed to air dry. The adhesion promoter was either wiped on, or brushed on, as indicated in Table 2. The adhesion promoter could also be sprayed on. The coatings were subjected to a force-dry for 10 minutes. A basecoat and clearcoat were applied. The basecoat was 2K (VIVAFLEX) SPECTRACRON FLEX casual black basecoat, with a clear topcoat, both commercially available from PPG Industries, Inc. The coatings were flashed at ambient temperature for 10 minutes, and cured for 20 minutes at 55° C. Cross-hatch adhesion was checked after 24 hours according to ASTM D3359. As can be seen in Table 2, below, the solvent blend alone gave no adhesion. The adhesion promoters of the present invention gave good adhesion.

TABLE 2

| | | Adhesion Rating: 5 = no pick off, | | |
|---|---|---|---|---|
| | | 0 = 100% pick off | | |
| | | Cross-Hatch Adhesion (Nichiban | | |
| | | Tape) | | |
| SYSTEM | Application | Back | Middle | Front |
| Solvent Blend | Wipe | 0 | 0 | 0 |
| 2% CPO/2% EVA | Wipe | 4 | 5 | 4 |
| Solvent* | | | | |
| 2% CPO/2% EVA | Brush | 5 | 5 | ND** |
| Solvent* | | | | |

*Solvent = 50/50 blend Methycyclohexane/n-BA ref. 05-041-94.
**ND = Not done.

### Example 2

Adhesion promoters were made according to Example 1 using the following components:

TABLE 3

| | Sample 1 | Sample 2 | Sample 3 | Sample 4 |
|---|---|---|---|---|
| Material | pph* (weight) | | | |
| CPO³ | 2.5 | 2.5 | 2.5 | 2.5 |
| EVA⁴ | 2.5 | 2.5 | 2.5 | 2.5 |
| Toluene (solvent 1) | 95 | | | |
| Xylene (solvent 2) | | 95 | | |
| Aromatic 100 (solvent 3) | | | 95 | |
| N-Butyl Acetate | | | | 95 |
| (solvent 4) | | | | |

³CPO 343-1.
⁴ELVAX 150W.
*parts per hundred

The samples of Table 3 were spray applied to EVA foam, fiberglass-reinforced nylon, and Mg—Al alloy parts. The samples were force-dried for about 10minutes. A 2K pigmented isocyanate/hydroxyl cure basecoat, as described in U.S. patent application Ser. No. 11/155,154, was spray applied; a clear coat was applied on top of the basecoat and the two coats were cured at about 52° C. Cross hatch adhesion was checked after 24 hours according to ASTM D3359. As can be seen in Table 4, there was excellent adhesion for all substrates.

TABLE 4

| | Adhesion Rating: 5 = no pick off, 0 = | | |
|---|---|---|---|
| | 100% pick off | | |
| See Formulas | Cross-Hatch Adhesion (D3359 3M | | |
| Table 3 | #810 tape) | | |
| SYSTEM | EVA | Nylon | Mg—Al alloy |
| SAMPLE 1 | 5 | 5 | 5 |
| SAMPLE 2 | 5 | 5 | 5 |
| SAMPLE 3 | 5 | 5 | 5 |
| SAMPLE 4 | 5 | 5 | 5 |

Whereas particular embodiments of this invention have been described above for purposes of illustration, it will be evident to those skilled in the art that numerous variations of the details of the present invention may be made without departing from the invention as defined in the appended claims.

What is claimed is:

1. A method for improving the adhesion between a substrate and a coating, comprising applying to the substrate a composition comprising:
(a) a chlorinated polyolefin; and
(b) a compound comprising ethylene vinyl acetate, wherein the substrate is ethylene vinyl acetate foam.

2. The method of claim 1, wherein the composition further comprises a non-aqueous solvent.

3. The method of claim 1, wherein the composition is HAPs free.

4. The method of claim 1, wherein the chlorinated polyolefin comprises chlorinated polypropylene.

5. The method of claim 1, wherein the chlorinated polyolefin has a chlorine content of 18 to 30 weight percent.

6. The method of claim 1, wherein the compound comprising ethylene vinyl acetate comprises vinyl acetate EVA.

7. The method of claim 1, wherein the composition comprises an ethylene vinyl acetate content of 25 to 40 weight percent.

8. A method for improving the adhesion between a substrate and a coating, comprising applying to the substrate a composition comprising:
(a) a chlorinated polyolefin; and
(b) a compound comprising ethylene vinyl acetate, wherein the substrate is polyurethane, and the composition excludes epoxy.

9. The method of claim 8, wherein the composition further comprises a non-aqueous solvent.

10. The method of claim 8, wherein the composition is HAPs free.

11. The method of claim 8, wherein the chlorinated polyolefin comprises chlorinated polypropylene.

12. The method of claim 8, wherein the chlorinated polyolefin has a chlorine content of 18 to 30 weight percent.

13. The method of claim 8, wherein the compound comprising ethylene vinyl acetate comprises vinyl acetate EVA.

14. The method of claim 8, wherein the composition comprises an ethylene vinyl acetate content of 25 to 40 weight percent.

15. A method for improving the adhesion between a substrate and a coating, comprising applying to the substrate a composition comprising:
(a) a chlorinated polyolefin; and
(b) a compound comprising ethylene vinyl acetate, wherein the substrate is fiberglass-reinforced plastic.

16. The method of claim 15, wherein the composition further comprises a non-aqueous solvent.

17. The method of claim 15, wherein the composition is HAPs free.

18. The method of claim 15, wherein the chlorinated polyolefin comprises chlorinated polypropylene.

19. The method of claim 15, wherein the chlorinated polyolefin has a chlorine content of 18 to 30 weight percent.

20. The method of claim 15, wherein the compound comprising ethylene vinyl acetate comprises vinyl acetate EVA.

21. The method of claim 15, wherein the composition comprises an ethylene vinyl acetate content of 25 to 40 weight percent.

22. A method for improving the adhesion between a substrate and a coating, comprising applying to the substrate a composition comprising:
(a) a chlorinated polyolefin; and
(b) a compound comprising ethylene vinyl acetate, wherein the substrate is metal.

23. The method of claim 22, wherein the composition further comprises a non-aqueous solvent.

24. The method of claim 22, wherein the composition is HAPs free.

25. The method of claim 22, wherein the chlorinated polyolefin comprises chlorinated polypropylene.

26. The method of claim 22, wherein the chlorinated polyolefin has a chlorine content of 18 to 30 weight percent.

27. The method of claim 22, wherein the compound comprising ethylene vinyl acetate comprises vinyl acetate EVA.

28. The method of claim 22, wherein the composition comprises an ethylene vinyl acetate content of 25 to 40 weight percent.

29. The method of claim 1, wherein the dry film thickness of the composition is 0.2 to 0.4 mils.

30. The method of claim 15, wherein the plastic is nylon.

31. The method of claim 8, wherein the polyurethane is thermoplastic urethane.

32. The method of claim 1, wherein the composition further comprises a graft copolymer comprising a chlorinated polyolefin and an acrylic polyol.

33. The method of claim 8, wherein the composition further comprises a graft copolymer comprising a chlorinated polyolefin and an acrylic polyol.

34. The method of claim 15, wherein the composition further comprises a graft copolymer comprising a chlorinated polyolefin and an acrylic polyol.

35. The method of claim 22, wherein the composition further comprises a graft copolymer comprising a chlorinated polyolefin and an acrylic polyol.
